(19) United States
(12) Patent Application Publication
(10) Pub. No.: US 2013/0138690 A1
(43) Pub. Date: May 30, 2013

(54) AUTOMATICALLY IDENTIFYING REUSED MODEL ARTIFACTS IN BUSINESS PROCESS MODELS

(71) Applicant: Julia Reisbich, Berlin (DE)

(72) Inventor: Julia Reisbich, Berlin (DE)

(73) Assignee: SAP AG, Walldorf (DE)

(21) Appl. No.: 13/307,317

(22) Filed: Nov. 30, 2011

(51) Int. Cl. G06F 17/30

(52) U.S. Cl. 707/772; 707/E17.014

(57) ABSTRACT

The present disclosure involves computer-implemented methods, software, and systems for automatically identifying reused model artifacts in business process models. A computer-implemented method includes identifying a consumable data object associated with a business process model, selecting a search area associated with the business process model to search for a reference to the consumable data object, searching within the selected search area for the at least one reference to the consumable data object, and determining at least one location of at least one data object that refers to the consumable data object.

### TECHNICAL FIELD

The present disclosure relates to computer-implemented methods, software, and systems for automatically identifying reused model artifacts in business process models.

### BACKGROUND

Business process models may be complex and contain several artifacts such as, for example, activities, sub-processes, events, and gateways, and other suitable artifacts. Artifacts may reference various reusable building blocks of the business process models, such as sub-processes, web services, scripting tasks, data mappings, and other suitable reusable building blocks. These reusable building blocks are generally exposed through service interfaces. It is desirable to reuse the artifacts to, among other things, provide increased consistency and efficiency to business process model development and to reduce the time and cost of business process model maintenance. To support desired reuse scenarios for the artifacts, all references to a specific service interface must be identified. This is currently a complicated and time-consuming endeavor in that a single service interface may be multi-dimensionally shared among workspaces, projects, and processes. This relational complexity affects, at a minimum, understanding, maintenance, and modification of the business process models. Currently the references must be identified manually and without the benefit of global or user-defined search operations, which is both inefficient and wasteful of business resources.

### SUMMARY

The present disclosure relates to computer-implemented methods, software, and systems for automatically identifying reused model artifacts in business process models. One computer-implemented method includes identifying a consumable data object associated with a business process model, selecting a search area associated with the business process model to search for a reference to the consumable data object, searching within the selected search area for the at least one reference to the consumable data object, and determining at least one location of at least one data object that refers to the consumable data object.

While generally described as computer-implemented software embodied on a non-transitory computer readable storage device that processes and transforms respective data, some or all of the aspects may be computer-implemented methods or further included in respective systems or other devices for performing this described functionality. The details of these and other aspects and implementations of the present disclosure are set forth in the accompanying drawings and the description below. Other features, objects, and advantages of the disclosure will be apparent from the description and drawings, and from the claims.

### DESCRIPTION OF DRAWINGS

FIG. 1 illustrates an example environment for automatically identifying reused model artifacts in business process models.

FIG. 2 is a flowchart of an example method for automatically identifying reused model artifacts in business process models.

FIGS. 3A & 3B illustrate example user interfaces and the selection of a search area.

FIGS. 4A & 4B illustrate example search results.

### DETAILED DESCRIPTION

This disclosure generally describes computer-implemented methods, software, and systems for automatically identifying reused model artifacts in business process models. Business process models may be complex and contain several artifacts such as, for example, activities, sub-processes, events, and gateways, and other suitable artifacts which may be multi-dimensionally shared among workspaces, projects and processes. Artifacts may also reference various reusable building blocks of the business process models, such as sub-processes, web services, scripting tasks, data mappings, and other suitable reusable building blocks. It is desirable to reuse the artifacts to, among other things, provide increased consistency and efficiency to business process model development and to reduce the time and cost of business process model maintenance. Specifically described are computer-implemented methods, software, and systems for automatically identifying reused model artifacts in business process models using at least a model artifact identification application. The model artifact identification application provides or supports functionality to identify a consumable data object associated with a business process model, select a search area to search for at least one reference to the consumable data object, search within at least one mapping associated with the selected search area for the at least one reference to the consumable data object, and determining at least one location of at least one data object associated with the at least one mapping that refers to the consumable data object.

Identification of all references to a specific service interface may be a time-consuming, cumbersome, and repetitive process, especially among multiple projects where cross-dependencies exist. The advantages of the present disclosure are numerous. First, allowing automatic identification of usage of the specific service interface increases the speed and accuracy of efforts to maintain and upgrade business process models and decreases inefficiency and waste of business resources. Multiple business process models may now be simultaneously modified, whereas prior efforts may require an extended period of time to accomplish the same task. Second, an accurate method of identifying the specific service interface and any inter-project dependencies mitigates potential impacts to data flow in other process models and minimizes business process interruptions and costly downtime. Further, accurate auditing procedures and records may be generated with respect to changes to the specific service interface in order to track and ensure business justifications for the changes. Constraints on deleting or updating reused artifacts may now be enforced.

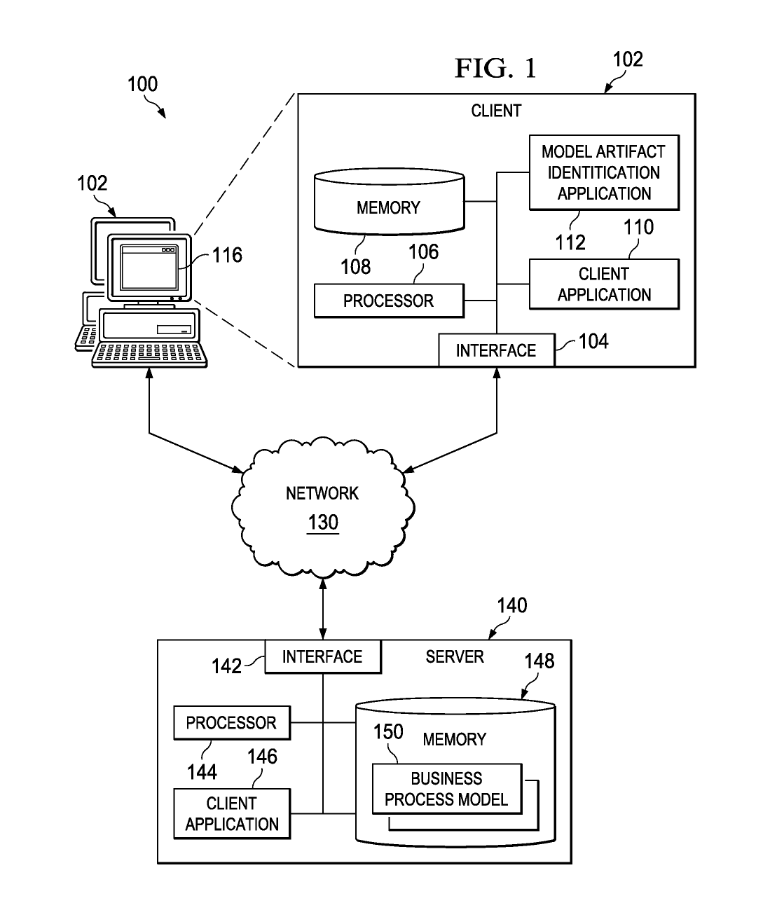

Turning to the figures, FIG. 1 illustrates an example environment 100 for implementing various features of a system for automatically identifying reused model artifacts in business process models in accordance with one implementation of the present disclosure. The illustrated environment 100 includes, or is communicably coupled with a client 102 and a server 140. The client 102 and the server 140 may communicate across or via network 130. In general, example environment 100 depicts an example configuration of a system for automatically identifying reused model artifacts in business process models. In alternative implementations, the elements illustrated within the client 102 and/or the server 140 may be included in or associated with different and/or additional servers, clients, networks, or locations other than those illustrated in FIG. 1. Additionally, the functionality associated with the client 102 may be associated with any suitable system, including by adding additional instructions, programs, applications, or other software to existing systems. For example, the components illustrated within the client 102 may be included in multiple clients, cloud-based networks, or other locations accessible to the client 102 (e.g., either directly or via network 130).

As used in the present disclosure, the term “computer” is intended to encompass any suitable general purpose processing device. The present disclosure also contemplates computers other than general purpose computers, as well as computers without conventional operating systems. Further, the illustrated client 102 and server 140 may be adapted to execute any physical or virtual operating system, including Linux, UNIX, Windows, Mac OS, WebOS, iOS, Android, or any other suitable operating system.

In general, the client 102 is any computer that provides for automatically identifying reused model artifacts in business process models via a model artifact identification application 112. Although FIG. 1 illustrates a single client 102, example environment 100 can be implemented using any number of clients.

At a high level, the client 102 comprises an electronic computing device operable to receive, transmit, process, store, or manage data and information associated with the example environment 100. The client 102 illustrated in FIG. 1 can be responsible for generating application requests to at least one server 140 (as well as any other entity or system interacting with the client 102), receiving responses to the generated requests, and processing said responses in an associated model artifact identification application 112. Accordingly, in addition to receiving responses from the external server 140 illustrated in FIG. 1, responses associated with requests generated by a particular model artifact identification application 112 may also be received from internal users, external or third-party customers, and other associated business applications, as well as any other appropriate entities, individuals, systems, or computers. In some implementations, the model artifact identification application 112 can be a web-based application accessing networked or cloud-based data and/or applications.

In the illustrated implementation of FIG. 1, the client 102 includes an interface 104, a processor 106, a memory 108, a client application 110, and a model artifact identification application 112. At a high level, each client application 110 and model artifact identification application 112 is an application, program, module, process, or other suitable software that may execute, change, delete, generate, or otherwise manage information associated with a particular client 102. While illustrated as a single component in the example environment 100 of FIG. 1, alternative implementations may illustrate the client 102 as comprising multiple parts or portions accordingly.

The interface 104 is used by the client 102 to communicate with other systems in a client-server or other distributed environment (including within example environment 100) connected to the network 130 (e.g., an associated server 140, as well as other systems communicably coupled to the network 130). FIG. 1 depicts both a client-server environment, but could also represent a cloud-computing network. Various other implementations of the illustrated example environment 100 can be provided to allow for increased flexibility in the underlying system, including multiple clients 102 performing or executing at least one additional or alternative implementations of the model artifact identification application 112, as well as other applications associated with or related to the model artifact identification application 112. In those implementations, the different clients 102 may communicate with each other via a cloud-based network or through the connections provided by network 130. Returning to the illustrated example environment 100, the interface 104 generally comprises logic encoded in software and/or hardware in a suitable combination and operable to communicate with the network 130. More specifically, the interface 104 may comprise software supporting at least one communication protocol associated with communications such that the network 130 or the interface's hardware is operable to communicate physical signals within and outside of the illustrated example environment 100.

As illustrated in FIG. 1, the client 102 includes a processor 106. Although illustrated as a single processor 106 in the client 102, two or more processors may be used in the client 102 according to particular needs, desires, or particular implementations of example environment 100. The processor 106 may be a central processing unit (CPU), a blade, an application specific integrated circuit (ASIC), a field-programmable gate array (FPGA), or another suitable component. Generally, the processor 106 executes instructions and manipulates data to perform the operations of the client 102 and, specifically, the functionality associated with the corresponding model artifact identification application 112. In one implementation, the client 102 processor 106 executes the functionality required to receive and process responses and instructions from the at least one server 140, as well as the functionality required to perform the operations of the associated client application 110.

Regardless of the particular implementation, “software” may include computer-readable instructions, firmware, wired or programmed hardware, or any combination thereof on a tangible and non-transitory medium operable when executed to perform at least the processes and operations described herein. Indeed, each software component may be fully or partially written or described in any appropriate computer language including C, C++, C#, Java, Visual Basic, assembler, Perl, any suitable version of 4GL, as well as others. It will be understood that while portions of the software illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components, as appropriate. In the illustrated example environment 100, each processor 106 executes the model artifact identification application 112 stored on the associated client 102. In some implementations, a particular client 102 can be associated with the execution of two or more model artifact identification applications 112, as well as at least one distributed application executing across two or more clients 102.

The client 102 also includes a memory 108 for storing data and program instructions. The memory 108 may include any memory or database module and may take the form of volatile or non-volatile memory including, without limitation, magnetic media, optical media, random access memory (RAM), read-only memory (ROM), flash memory, removable media, or any other suitable local or remote memory component. The memory 108 may store various objects or data, including classes, frameworks, applications, backup data, business objects, jobs, web pages, web page templates, database tables, process contexts, repositories storing services local to the client 102, and any other appropriate information including any parameters, variables, algorithms, instructions, rules, constraints, or references thereto associated with the purposes of the client 102, client application 110, and model artifact identification application 112. In some implementations, including a cloud-based system, some or all of the memory 108 can be stored remote from the client 102, and communicably coupled to the client 102 for usage.

At least one client application 110 is illustrated within the client 102. Further, although illustrated as a single client application 110, the client application 110 may be implemented as multiple client applications 110 in the client 102. The client application 110 of the client 102 may retrieve application-related information from a corresponding client 102, or the client application may access a local cached set of client-application-related information (not shown) stored on the client 102. In some implementations, the client application 110 can be a web browser. In some implementations, the client-application 110 can use parameters, metadata, and other information received at launch to access a particular set of data from the client 102. Once a particular client application 110 is launched, a user may interactively process a task, event, or other information associated with the client 102. Further, although illustrated as a single client application 110, the client application 110 may be implemented as multiple client applications in the client 102.

At least one model artifact identification application 112 is illustrated within the client 102. Further, although illustrated as a single model artifact identification application 112, the model artifact identification application 112 may be implemented as multiple model artifact identification applications 112 in the client 102. The model artifact identification application 112 can be any application, program, module, process, or other software that may execute, change, delete, generate, or otherwise manage information associated with a particular client 102 and/or server 140. The model artifact identification application 112 provides functionality for automatically identifying reused model artifacts in business process models. In some implementations, the model artifact identification application 112 may identify a consumable data object associated with a business process model. In some implementations, the model artifact identification application 112 may also be used to select a search area associated with the business process model to search for a reference to the consumable data object. Further, in other implementations, the model artifact identification application 112 may allow searching within at least one mapping associated with the identified search area for the consumable data object. In still other implementations, the model artifact identification application 112 may also allow the determination of at least one location of at least one data object associated with the at least one mapping that consumes the consumable data object and the generation of search results containing at least the at least one determined location. In alternate implementations, a model artifact identification application 112 on server 140 (not shown) may be executed by the server 140 and be accessed by the client 102 via a browser executing on the client 102. In some implementations, each model artifact identification application 112 can represent a Web-based application accessed and executed by a browser or other suitable application associated with client 102 or by remote clients 102 via the network 130 (e.g., through the Internet, or via at least one cloud-based service associated with the model artifact identification application 112). Additionally, a particular model artifact identification application 112 may operate in response to and in connection with at least one request received from other model artifact identification applications 112, including a model artifact identification application 112 associated with another client 102 and/or server 140. Moreover, any or all of a particular model artifact identification application 112 may be a child or sub-module of another software module or enterprise application (not illustrated) without departing from the scope of this disclosure.

The GUI 116 of the client 102 is a graphical user interface operable to allow the user of the client 102 to interface with at least a portion of the system 100 for any suitable purpose, including to allow a user of the client 102 to interact with the client application 110, model artifact identification application 112, and with the client 102. The term “Graphical User Interface”, or GUI, may be used in the singular or plural to describe at least one graphical user interface and each of the displays of a particular graphical user interface. Therefore, the GUI 116 can be any graphical user interface, such as a generic web browser, touch screen, or command line interface (CLI) that processes information in the system 100 and efficiently presents the results to a user. Generally the GUI 116 provides the client 102 with an efficient and user-friendly presentation of data provided by or communicated within the system 100. In particular, the GUI 116 may provide users of the client 102 with visualized representation of the client application 110, model artifact identification application 112, and other client 102 functionality. The GUI 116 may include a plurality of user interface elements such as interactive fields, pull-down lists, buttons, and other suitable user interface elements operable at the client 102.

Generally, the client 102 may be communicably coupled with a network 130 that facilitates wireless or wireline communications between the components of the example environment 100 (i.e., between the client 102 and at least one server 140), as well as with any other local or remote computer, such as additional clients, servers, or other devices communicably coupled to network 130, including those not illustrated in FIG. 1. In the illustrated example environment 100, the network 130 is depicted as a single network, but may be comprised of more than one network without departing from the scope of this disclosure, so long as at least a portion of the network 130 may facilitate communications between senders and recipients. In some implementations, at least one component associated with the client 102 can be included within the network 130 as at least one cloud-based service or operation. The network 130 may be all or a portion of an enterprise or secured network, while in another implementation, at least a portion of the network 130 may represent a connection to the Internet. In some implementations, a portion of the network 130 can be a virtual private network (VPN). Further, all or a portion of the network 130 can comprise either a wireline or wireless link. Example wireless links may include cellular, 802.11a/b/g/n, 802.20, WiMax, and/or any other appropriate wireless link. In other words, the network 130 encompasses any internal or external network, networks, sub-network, or combination thereof operable to facilitate communications between various computing components inside and outside the illustrated example environment 100. The network 130 may communicate, for example, Internet Protocol (IP) packets, Frame Relay frames, Asynchronous Transfer Mode (ATM) cells, voice, video, data, and other suitable information between network addresses. The network 130 may also include at least one local area network (LAN), radio access network (RAN), metropolitan area network (MAN), wide area network (WAN), all or a portion of the Internet, and/or any other communication system or systems in at least one location. The network 130, however, is not a required component in some implementations of the present disclosure.

In general, the server 140 is any computer that provides support to the client 102 for automatically identifying reused model artifacts in business process models via the business application 146, memory 148, and at least one business process model 150. The at least one business process model 150 instance may reside either locally or remote to the server 140. Although FIG. 1 illustrates a single server 140, example environment 100 can be implemented using any number of servers.

For example, each server 140 may be a Java 2 Platform, Enterprise Edition (J2EE)-compliant application server that includes Java technologies such as Enterprise JavaBeans (EJB), J2EE Connector Architecture (JCA), Java Messaging Service (JMS), Java Naming and Directory Interface (JNDI), and Java Database Connectivity (JDBC). In some implementations, other non-Java based servers and or systems could be used for the server 140. In some implementations, each server 140 can store and execute a plurality of various other applications (not shown), while in other implementations, each server 140 may be a dedicated server meant to store and execute a particular business application 146 and its related functionality. In some implementations, the server 140 can comprise a Web server or be communicably coupled with a Web server, where the business application 146 associated with that server 140 represents a Web-based (or Web-accessible) application accessed and executed on an associated at least one client 102 to perform the programmed tasks or operations of the corresponding business application 146. In still other instances, the business application 146 may be executed on a first system, while the business application 146 manipulates and/or provides information for data located at a remote, second system. In the illustrated example, the business application 146 is local to the server 140.

At a high level, the server 140 comprises an electronic computing device operable to receive, transmit, process, store, or manage data and information associated with the example environment 100. The server 140 illustrated in FIG. 1 can be responsible for receiving application requests from the at least one client 102 (as well as any other entity or system interacting with the server 140), responding to the received requests by processing said requests in an associated business application 146, and sending the appropriate responses from the business application 146 back to the requesting client 102 or other requesting system. The business application 146 can also process and respond to local requests from a user locally accessing the associated server 140. Accordingly, in addition to requests from the external client 102 illustrated in FIG. 1, requests associated with a particular business application 146 may also be sent from internal users, external or third-party customers, and other associated business applications, as well as any other appropriate entities, individuals, systems, or computers. In some implementations, the business application 146 can be a Web-based application executing functionality associated with the networked or cloud-based business process.

In the illustrated implementation of FIG. 1, the server 140 includes a processor 144, at least one business application 146, a memory 148, and an interface 152. While illustrated as a single component in the example environment 100 of FIG. 1, alternative implementations may illustrate the server 140 as comprising multiple parts or portions accordingly.

In some implementations, processor 144 can be similar to processor 106. In other implementations, the processor 144 may be a processor designed specifically for use in server 140. Further, although illustrated as a single processor 144, the processor 144 may be implemented as multiple processors in the server 140. Regardless of the type and number, the processor 144 executes instructions and manipulates data to perform the operations of the server 140, including operations to receive and process requests from client 102 or other suitable request source, access data within memory 148, and execute the business application 146 as well as perform other operations associated with the server 140.

Memory 148 of the server 140 may include any memory or database module and may take the form of volatile or non-volatile memory including, without limitation, magnetic media, optical media, random access memory (RAM), read-only memory (ROM), removable media, or any other suitable local or remote memory component. For example, memory 148 may store a business application 146, backup data, parameters, cookies, variables, algorithms, instruction, rules, or reference thereto. As illustrated, memory 148 can include any suitable components to interpret and decode requests and messages received at the server 140. Further, although illustrated as a single memory 148, the memory 148 may be implemented as multiple memories in the server 140. The memory 148 also store at least one business process model 152.

In various implementations, at least one business process model 152 defines a set of process steps operable to perform a defined business process. Each process step of at least one business process model 152 defines at least one business-related activity and is linked to at least one other process step by at least one process flow rule. The process flow rules define and manage a process flow through the at least one business process model 152.

At least one business application 146 is illustrated within the server 140. The business application 146 can be any application, program, module, process, or other software that may execute, change, delete, generate, or otherwise manage information associated with a particular server 140, and in some cases, a business process performing and executing business process-related events. In particular, business processes communicate with other users, applications, systems, and components to send and receive events. In some implementations, a particular business application 146 can operate in response to and in connection with at least one request received from an associated client 102. Additionally, a particular business application 146 may operate in response to and in connection with at least one request received from other business applications 146, including a business application 146 associated with another server 140. In some implementations, each business application 146 can represent a Web-based application accessed and executed by remote clients 102 via the network 130 (e.g., through the Internet, or via at least one cloud-based service associated with the business application 146). Further, while illustrated as internal to the server 140, the at least one business processes model 150 associated with a particular business application 146 may be stored, referenced, or executed remotely. For example, a portion of a particular business application 146 may be a web service associated with the business application 146 that is remotely called, while another portion of the business application 146 may be an interface object or agent bundled for processing at a remote client 102. Moreover, any or all of a particular business application 146 may be a child or sub-module of another software module or enterprise application (not illustrated) without departing from the scope of this disclosure. Still further, portions of the particular business application 146 may be executed or accessed by a user working directly at the server 140, as well as remotely at a corresponding client 102. In some implementations, the server 140 can execute the at least one business process model 148 using the at least one business application 146.

The interface 152 of the server 140 may be similar to the interface 104 of the client 102, in that it may comprise logic encoded in software and/or hardware in a suitable combination and operable to communicate with the network 130. More specifically, interface 152 may comprise software supporting at least one communication protocol such that the network 130 or hardware is operable to communicate physical signals to and from the server 140. Further, although illustrated as a single interface 152, the interface 152 may be implemented as multiple interfaces in the server 140.

While FIG. 1 is described as containing or being associated with a plurality of components, not all components illustrated within the illustrated implementation of FIG. 1 may be utilized in each implementation of the present disclosure. Additionally, at least one component described herein may be located external to example environment 100, while in other implementations, certain components may be included within or as a portion of at least one described component, as well as other components not described. Further, certain components illustrated in FIG. 1 may be combined with other components, as well as used for alternative or additional purposes, in addition to those purposes described herein.

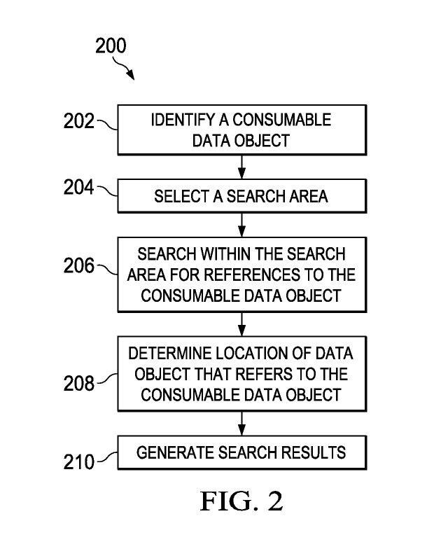

FIG. 2 illustrates a flowchart of an example method 200 for implementing various features of a system for automatically identifying reused model artifacts in business process models. For clarity of presentation, the description that follows generally describes method 200 in the context of example environment 100 illustrated in FIG. 1. However, it will be understood that method 200 may be performed, for example, by any other suitable system, environment, or combination of systems and environments, as appropriate.

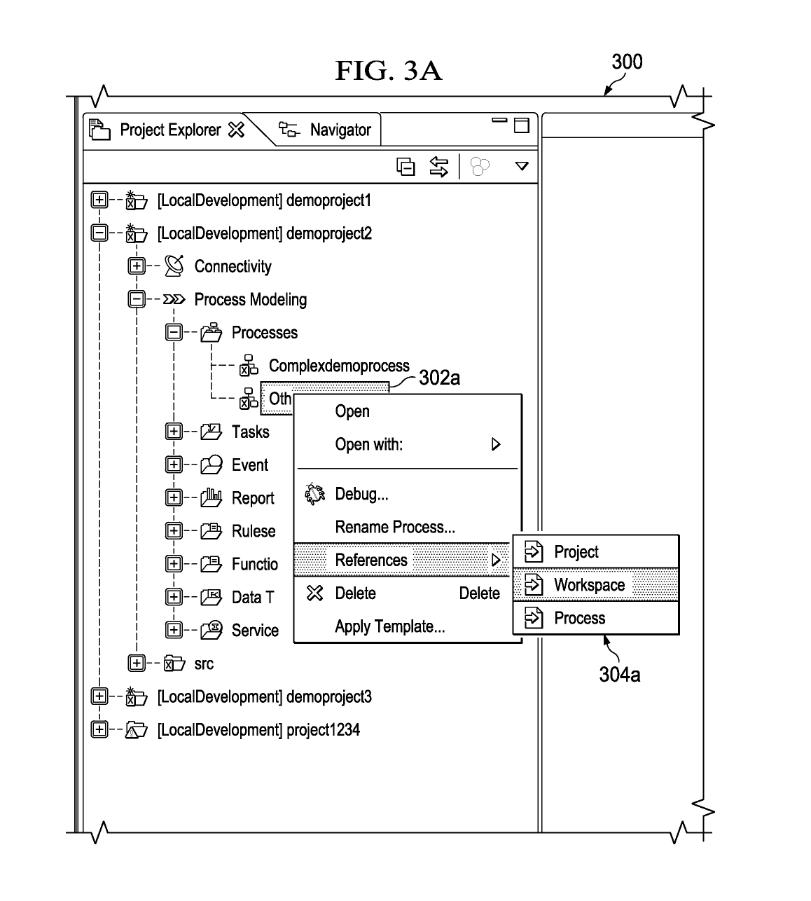

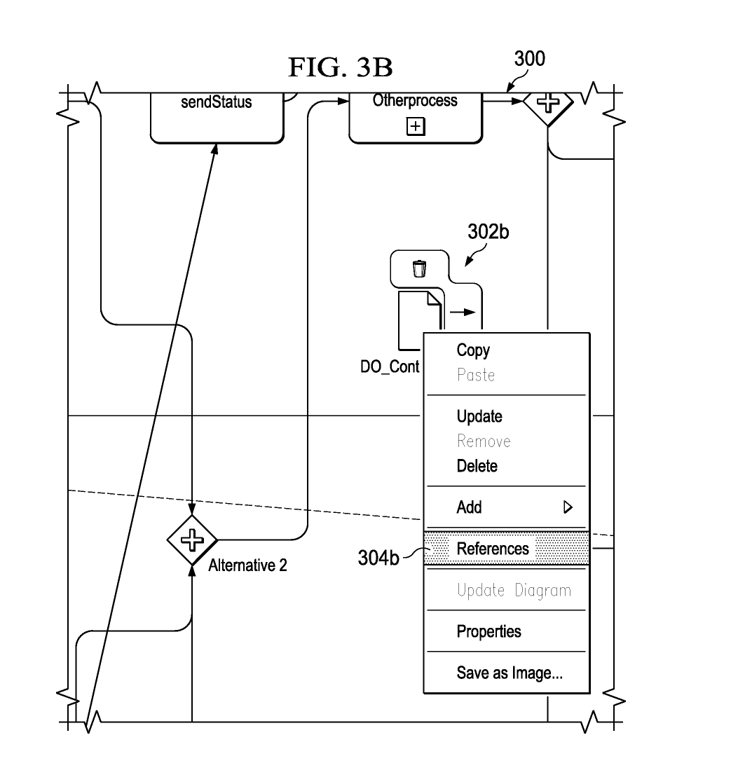

Referring now to FIG. 2, method 200 begins at 202. At 202, a consumable data object is identified. Identifying may be performed using, for example, a computer mouse, keyboard, stylus, touch screen, an algorithm, voice recognition or other suitable identification method and/or tool. For example, FIG. 3A shows the process 302a “Otherprocess” as identified in a process composer tool. Likewise, FIG. 3B shows the data object 302b “DO_Content” as identified in a diagram editor tool. Responsive to a determination that an indication of an identification of a consumable data object was received, the identification is indicated and method 200 proceeds to 204. In some implementations, the identification indication can be made through sound, color, text, animation, or other suitable indication. In some implementations, the indication can be persistent. In other implementations, the indication may not be persistent. From 202, method 200 proceeds to 204.

At 204, a search area associated with the business process model to search for a reference to the consumable data object is selected. Selecting may be performed using, for example, a computer mouse, keyboard, stylus, touch screen, an algorithm, voice recognition or other suitable selection method and/or tool. For example, FIG. 3A shows the search areas 304a available (i.e., “Project”, “Workspace”, and “Process”) to search for references to process 302a. In this example, as in some implementations, the process 302a within a workspace can be reused in other projects or processes within the workspace and the available search areas would be indicated as such. In another example, FIG. 3B shows that only “References” 304b to the data object 302b may be searched for within the corresponding business process model. In this example, as in some implementations, data object 302b can be created within a single business process model and only be reused within the single business process. As there would be no usage external to the single business process, only “References” may be displayed on a context menu. In other implementations, this situation may be indicated in alternative ways, such as by an icon, image, or other suitable indicator. Responsive to a determination that an indication of a selection of a search area was received, the selection is indicated and method 200 proceeds to 206. In some implementations, the selection indication can be made through sound, color, text, animation, or other suitable indication. In some implementations, the indication can be persistent. In other implementations, the indication may not be persistent. From 204, method 200 proceeds to 206.

At 206, the selected search area is searched for at least one reference to the identified consumable data object. For example, for a search for an identified process (e.g., MyProcess1) within a project (e.g., Project1) in a workspace, all processes and sub-processes within each project in the workspace may be searched for a reference to the identified process. In some implementations, a search can be performed by one or more calls to services, web services, API's, functions or other suitable search calls. Depending on the identified consumable object and the search area selected, the data searched for references to the identified consumable data object may vary as well as the operations used to perform the search including both public and proprietary techniques. From 206, method 200 proceeds to 208.

At 208, at least one location of at least one data object that refers to the identified consumable data object is determined. For example, a separate project (e.g., Project2) in the workspace may contain a sub-process (e.g., MySubProcess1) that refers to MyProcess1. In some implementations, a location determination can be performed by one or more calls to services, web services, API's, functions or other suitable location determination calls. Depending on the identified consumable object and the search area selected, the locations of data objects referring to the identified consumable data object may vary as well as the operations used to perform the location determination including both public and proprietary techniques. From 208, method 200 proceeds to 210.

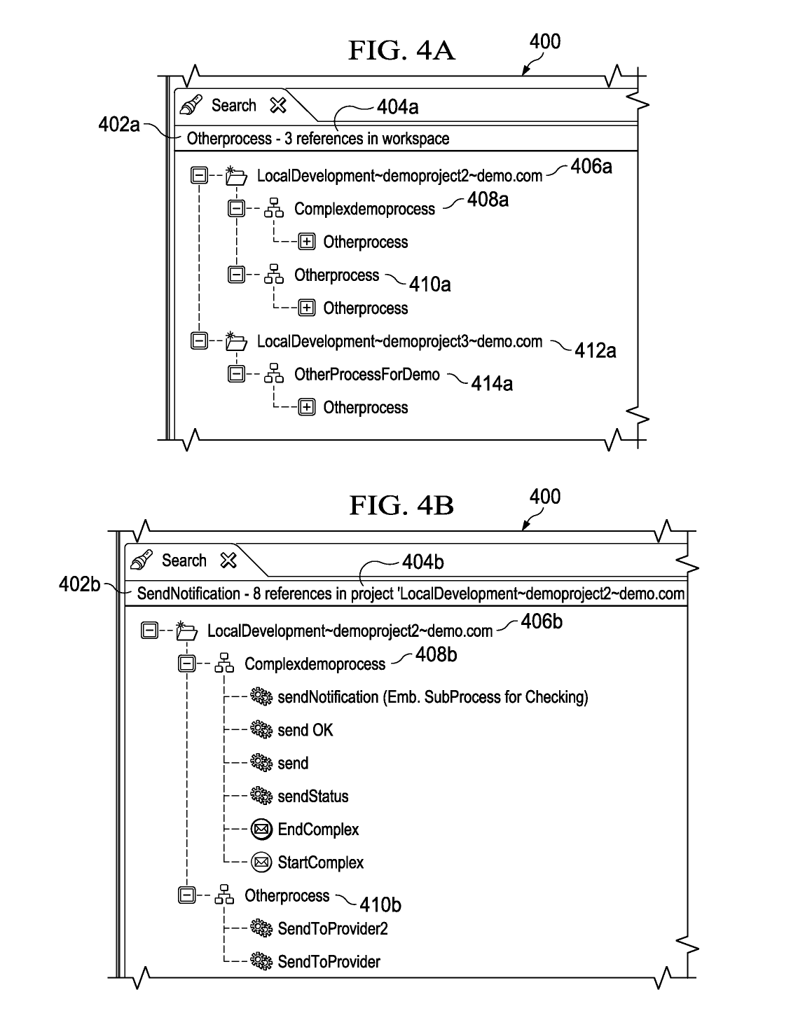

At 210, search results containing at least the at least one determined location are generated. For example, FIG. 4A shows the generated search results for the process 402a “Otherprocess” in a workspace. “Otherprocess” is shown to be referred to three times in the workspace 404a. Project 406a “LocalDevelopment˜demoproject2˜demo.com” has two references (i.e., once in the process 408a “Complexdemoprocess” and once in the process 410a “Otherprocess”). Project 412a “LocalDevelopment˜demoproject3˜demo.com” has one reference (i.e., within process 412a “OtherProcessForDemo”). Similarly, FIG. 4B shows the generated search results for the service interface 402b “SendNotification in a project 404b “LocalDevelopment˜demoproject2˜demo.com.” The service interface 402b is shown to be referred to eight times in the project 406b “LocalDevelopment˜demoproject2˜demo.com” (i.e., six times in the process 408b “Complex demoprocess” and two times in the process 410b “Otherprocess”). Returned search results may vary depending upon the type of data object search for and the search area. For example, searching for a sub-process in a workspace may return results similar to:
Project1
   Process1
      Referenced sub-process1
Project2
   Process2
      Referenced sub-process2

Searching for a sub-process in a project may return search results similar to:
Project1
   Process1
      Referenced sub-process1
      Referenced sub-process2

Searching for a sub-process in a process may return search results similar to:
Process1
   Referenced sub-process1
   Referenced sub-process2

Searching for a service interface in a workspace may return search results similar to:
Project1
   Process1
      AutomatedActivity1
      AutomatedActivity2
Project2
   Process2
      AutomatedActivity3

Searching for a service interface in a project may return search results similar to:
Project1
   Process1
      Automated Activity1
      Automated Activity2
      Start Event1
         In some implementations, search results are not stored. In some implementations, search results are displayed to a user using a GUI. From 210, method 200 stops.

The preceding figures and accompanying description illustrate example processes and computer implementable techniques. But example environment 100 (or its software or other components) contemplates using, implementing, or executing any suitable technique for performing these and other tasks. It will be understood that these processes are for illustration purposes only and that the described or similar techniques may be performed at any appropriate time, including concurrently, individually, in parallel, and/or in combination. In addition, many of the steps in these processes may take place simultaneously, concurrently, in parallel, and/or in different orders than as shown. Moreover, example environment 100 may use processes with additional steps, fewer steps, and/or different steps, so long as the methods remain appropriate.

In other words, although this disclosure has been described in terms of certain implementations and generally associated methods, alterations and permutations of these implementations and methods will be apparent to those skilled in the art. Accordingly, the above description of example implementations does not define or constrain this disclosure. Other changes, substitutions, and alterations are also possible without departing from the spirit and scope of this disclosure.

1. A computer-implemented method, comprising:
identifying, using at least one computer, a consumable data object, wherein the consumable data object is associated with a first search area associated with a workspace;
selecting at least one additional search area associated with the workspace;
identifying at least one additional reference to the consumable data object within the selected at least one additional search area; and
determining a location of at least one data object in the at least one additional search area, wherein each at least one data object incorporates at least one additional reference of the at least one identified additional reference to the consumable data object.

2. The computer-implemented method of claim 1, wherein the consumable data object is selected from at least one of a process, a task, an event trigger, a function, a rule set, a data type, a service interface, and a service interface operation.

3. The computer-implemented method of claim 2, wherein the search area is selected from at least one of a workspace, a project, and a process.

4. The computer-implemented method of claim 1, wherein the searching is performed using a modeling query language.

5. The computer-implemented method of claim 1, wherein the searching is performed using a metadata model.

6. The computer-implemented method of claim 1, further comprising generating search results containing at least the determined location.

7. A non-transitory, computer-readable medium storing computer-readable instructions executable by a data processing apparatus to perform operations comprising:
identifying a consumable data object, wherein the consumable data object is associated with a first search area associated with a workspace;
selecting at least one additional search area associated with the workspace;
identifying at least one additional reference to the consumable data object within the selected at least one additional search area; and
determining a location of at least one data object in the at least one additional search area, wherein each at least one data object incorporates at least one additional reference of the at least one identified additional reference to the consumable data object.

8. The medium of claim 7, wherein the consumable data object is selected from at least one of a process, a task, an event trigger, a function, a rule set, a data type, a service interface, and a service interface operation.

9. The medium of claim 8, wherein the search area is selected from at least one of a workspace, a project, and a process.

10. The medium of claim 7, wherein the searching is performed using a modeling query language.

11. The medium of claim 7, wherein the searching is performed using a metadata model.

12. The medium of claim 7, further comprising generating search results containing at least the determined location.

13. A system for automatically identifying reused model artifacts in business process models, comprising:
a data processing apparatus configured to:
identify a consumable data object, wherein the consumable data object is associated with a first search area associated with a workspace;
select at least one additional search area associated with the workspace;
identify at least one additional reference to the consumable data object within the selected at least one additional search area; and
determine a location of at least one data object in the at least one additional search area, wherein each at least one data object incorporates at least one additional reference of the at least one identified additional reference to the consumable data object.

14. The system of claim 13, wherein the consumable data object is selected from at least one of a process, a task, an event trigger, a function, a rule set, a data type, a service interface, and a service interface operation.

15. The system of claim 14, wherein the search area is selected from at least one of a workspace, a project, and a process.

16. The system of claim 13, wherein the searching is performed using a modeling query language.

17. The system of claim 13, wherein the searching is performed using a metadata model.

18. The system of claim 13, further comprising generating search results containing at least the determined location.
